(19) United States
(12) Patent Application Publication
(10) Pub. No.: US 2014/0152444 A1
(43) Pub. Date: Jun. 5, 2014

(54) APPARATUS FOR MEASURING DRIVER'S VISUAL FATIGUE

(71) Applicant: HYUNDAI MOTOR COMPANY, Seoul (KR)

(72) Inventor: Hwal Ly Lee, Seoul (KR)

(73) Assignee: HYUNDAI MOTOR COMPANY, Seoul (KR)

(21) Appl. No.: 13/841,601

(22) Filed: Mar. 15, 2013

(30) Foreign Application Priority Data
Dec. 5, 2012 (KR) 10-2012-0140136

(51) Int. Cl. G08B 21/06

(52) U.S. Cl. CPC G08B 21/06
USPC 340/575

(57) ABSTRACT

Disclosed herein is an apparatus for measuring a driver's visual fatigue. The apparatus includes a ground electrode that is mounted near the driver's ear, and a measuring electrode that is mounted near the driver's eye. Furthermore, the apparatus includes a controller that is configured to induce a resting potential using measured values of the ground electrode and the measuring electrode. When the resting potential is beyond a predetermined range, the controller is configured to determine the visual fatigue to be above a predetermined threshold and output a fatigue signal.

### BACKGROUND OF THE INVENTION

1. Field of the Invention

The present invention relates, in general, to an apparatus for measuring a driver's visual fatigue, in which a driver's eyes that are processing driving information are measured using an electrophysiological method to determine the driver's physical state and thus provide the driver with increased safety.

2. Description of the Related Art

The present application relates to a driving safety support technology that has recently been developed. Although the many safe driving systems use the method of determining the driver's physical state, it may be difficult to accomplish precise measurement due to difficulty in measurement and the deviation between measurers, and thus, related art techniques are restricted in their application to mass production.

An object of the present application is to provide a driver with increased convenience and safety by measuring the driver's eyes using an electrophysiological method to more precisely determine the driver's physical state.

A conventional system for measuring a driver's physical state uses a camera to detect the direction of a face or the opening/closing of eyes to determine the driver's alertness and ability to safely drive a vehicle. Further, in such a conventional system, once the driver's alertness has been determined, a sign, for example, a coffee cup, may be displayed on a cluster section of a vehicle to advise the driver to cease driving. However, the measurements obtained using the conventional system may not be substantially precise to be sufficient for mass production.

Another recently developed system includes an eye-movement measuring system in which an image-nystagmograph and an electronystagmograph are combined. In the system, an eye image obtained by a camera is first examined to find a boundary between the pupil and the iris using a fanlike window. Then, if there are failed boundary coordinates due to the pupil being hidden by the eyelid or surrounding distractions such as eyebrows, distractions are removed by using the distance between boundary coordinates, to obtain optimum values of the central point and radius of the pupil using a circle (or an oval). Then, a rotary angle of the eye is measured using an iris pattern at a distance apart from the boundary of the pupil. According to the proposed method, it may be possible to measure the eye movement for a longer period of time while reducing the burden of requiring a eyes to be wise open. Further, the rotary angle of the eye may be obtained with less susceptibility to a variation in the size of the pupil. However, such techniques may not directly measure the fatigue of eyes to determine the driver's fatigue.

Those description described in the related art are provided only for understanding of the background of the invention, and it should not be understood that they are admitted to correspond to the known related art technology by ordinary skilled persons in the art.

### SUMMARY

Accordingly, the present invention provides an apparatus for measuring a driver's visual fatigue, in which a driver's eyes that are processing driving information are measured using an electrophysiological method to determine the driver's physical state and thus provide the driver with increased safety.

According to one embodiment of the present invention, an apparatus for measuring a driver's visual fatigue includes: a ground electrode mounted near the driver's ear; a measuring electrode mounted near the driver's eye; and a controller configured to induce a resting potential using measured values of the ground electrode and the measuring electrode and, when the resting potential is beyond a predetermine range, determine the visual fatigue to be above a predetermined threshold, and output a fatigue signal. The measuring electrode may be mounted between the driver's eye and nose.

The controller may be configured to determine the visual fatigue to be above the predetermined threshold when the resting potential is below 1.6 mV or above 1.8 mV. The controller may be further configured to output a fatigue signal when the resting potential is below 1.6 mV or above 1.8 mV for a certain length of time.

According to another aspect of the present invention, an apparatus for measuring a driver's visual fatigue includes: a pair of spectacles having a nose pad, lenses, and temple arms; a ground electrode disposed at an end of the temple arm near the driver's ear; a measuring electrode provided at the nose pad close to the driver's eye; and a controller configured to induce a resting potential using measured values of the ground electrode and the measuring electrode and, when the resting potential is beyond a predetermined range, determine the visual fatigue to be above a predetermined threshold, and output a fatigue signal.

The measuring electrode may comprise a plurality of electrode units disposed near the left and right sides of the driver's eye, respectively. The measuring electrode may comprise a plurality of electrode units disposed near upper, lower, left, and right sides of the driver's eye, respectively.

According to an apparatus for measuring a driver's visual fatigue, driving safety is improved. Furthermore, the apparatus may define more definite determination standards with regard to a dangerous driving condition while measuring the driver's visual fatigue using cost-effective electrodes based on the principle of a human body, thereby improving operation performance in association with a driving system and thus enabling safe driving.

Further, since visual information is output to the driver in a vehicle via a cluster, an audio/video and navigation system (AVN), a head-up display (HUD), or the like, the present technology may provide an optimized quantity of driving information (degree and standard) to the driver.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is an exemplary diagram of an apparatus for measuring a driver's visual fatigue according to an exemplary embodiment of the present invention;

FIG. 2 is an exemplary view of the apparatus for measuring a driver's visual fatigue according to an exemplary embodiment of the present invention; and

FIG. 3 is an exemplary graph of an exemplary measurement using the apparatus for measuring a driver's visual fatigue according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Furthermore, control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Reference will now be made in greater detail to a exemplary embodiment of the invention, an example of which is illustrated in the accompanying drawings. Wherever possible, the same reference numerals will be used throughout the drawings and the description to refer to the same or like parts.

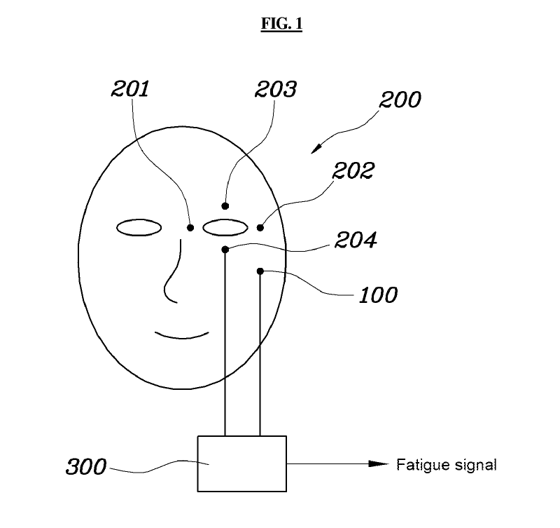

FIG. 1 is an exemplary diagram of an apparatus for measuring a driver's visual fatigue according to an exemplary embodiment of the present invention. The apparatus may include a ground electrode 100 mounted near a driver's ear, a measuring electrode 200 mounted near the driver's eye, and a controller 300 configured to induce a resting potential using measured values from the ground electrode and the measuring electrode; determine the visual fatigue is above a predetermined threshold when the resting potential is beyond a predetermined range; and output a fatigue signal.

The present invention relates to an apparatus using the resting potential of the eye. An electrical potential exists between the cornea and the retina of the eye. Accordingly, the pupil moves like a dipole, thus each time the pupil moves in every direction, a certain magnitude of the potential changes (e.g., 1.6˜4.7 mV), causing difficulty in anticipating the movement of the pupil according to the change.

Based on this principle, in the medical world, a method of determining whether a retinal epithelial cell is in a normal state (e.g., within the certain magnitude of the potential changes 1.6˜1.7 mV)has been developed. The present invention is an apparatus used to measure the visual fatigue of the eye based on the same principle and theory.

Moreover, the eyeball moves using the superior rectus muscle, the inferior rectus muscle, the medial rectus muscle, the lateral rectus muscle, the superior oblique muscle, and inferior oblique muscle. The medial and lateral rectus muscles allow the eyeball to move in the medial and lateral directions, and the superior and inferior rectus muscles and the superior and inferior oblique muscles allow complex movement of the eyeball such as upward, downward, or oblique movement

As the amount of visual information output to the driver increases, the more the eye-muscles active movement increases, causing muscle fatigue. Since the fatigue directly induces a variation in electromyogram, the present invention provides an apparatus and method for measuring electromyogram of the eye as a variation in the resting potential. An electromyogram-measuring input terminal uses an Silver/Silver Chloride (Ag/AgCl) electrode to measure the eye-movement according to the time and the quantity of information output to the driver.

FIG. 1 is an exemplary diagram of an apparatus for measuring a driver's visual fatigue according to an exemplary embodiment of the present invention, wherein respective points on the figure are the locations at which electrodes may be attached, and the respective electrodes are configured to measure variations in the voltage with respect to changes in an angle of the eyeball. When measuring variations in the eye-movement before and after driving, a driver's visual load and fatigue may be determined due to frequent movement of the muscles around the eyeball resulting from the reception of visual information, that is, how the state of the driver's eyes changes. The measured voltage may be analyzed in a Fast Fourier Transform (FFT) method to compare the voltage before and after the changes occur.

FIG. 3 is an exemplary graph of exemplary measurement using the apparatus for measuring a driver's visual fatigue according to an exemplary embodiment of the present invention. As illustrated in the graph, variations in the voltage with respect to the eye-movement were irregular according to the time before and after driving, and the amplitudes were within the abnormal range (e.g., beyond the range 1.6˜1.8 mV). The exemplary graph shows that the muscle fatigue around the eyeball caused by the reception of visual information may be substantially precisely measured according to the present invention.

Thus, the controller 300 may be configured to induce the resting potential using measurements of the ground electrode 100 and the measuring electrode 200. The resting potential values are shown in the graph of FIG. 3. In the graph, when the resting potential is beyond a predetermine range, the visual fatigue may be determined to be above a predetermined threshold, and a fatigue signal may be output. The graphical values of FIG. 3 are amplified values. Specifically, when the resting potential is beyond a range of 1.6˜1.8 mV, the controller 300 may be configured to determine the visual fatigue to be above the predetermined threshold.

For example, as illustrated, when a driver operates a vehicle for 2 hours, the resting potential is often beyond the range of 1.6˜8 mV. This means that the driver's eyes are in a burdened state beyond the resting state. In other words, the muscles around the eye may operate abnormally or in a strained state, exhibiting different levels of strength compared to in the normal state. Thus, the state prior to driving or the state after up to 30 minutes of driving had a resting potential within a normal range (e.g., within the range of 1.6˜1.8 mV, meaning the eyes were not fatigued, whereas the state of after 1 or 2 hours of driving showed that the eyes were fatigued (e.g., beyond the range of 1.6˜1.8 mV).

Furthermore, the measuring electrode 200 may be mounted between the driver's eye and nose. Since drivers generally move their eyes in a horizontal direction rather than a vertical direction, measurement of horizontal resting potential is more advantageous in determining the state of a driver's eye. Moreover, when an eyeglasses-type measurer is used, the location between the eye and nose is an appropriate location to examine the horizontal eye-movement.

Further, the controller 300 may be configured to determine the visual fatigue to be above a predetermined threshold and output a fatigue signal when the resting potential is beyond the range between 1.6 mV and 1.8 mV for a certain length of time. In other words, a slight deviation of the resting potential beyond the range may be measured as well as a longer duration time of the resting potential beyond the range, to more accurately determine the eye fatigue without errors.

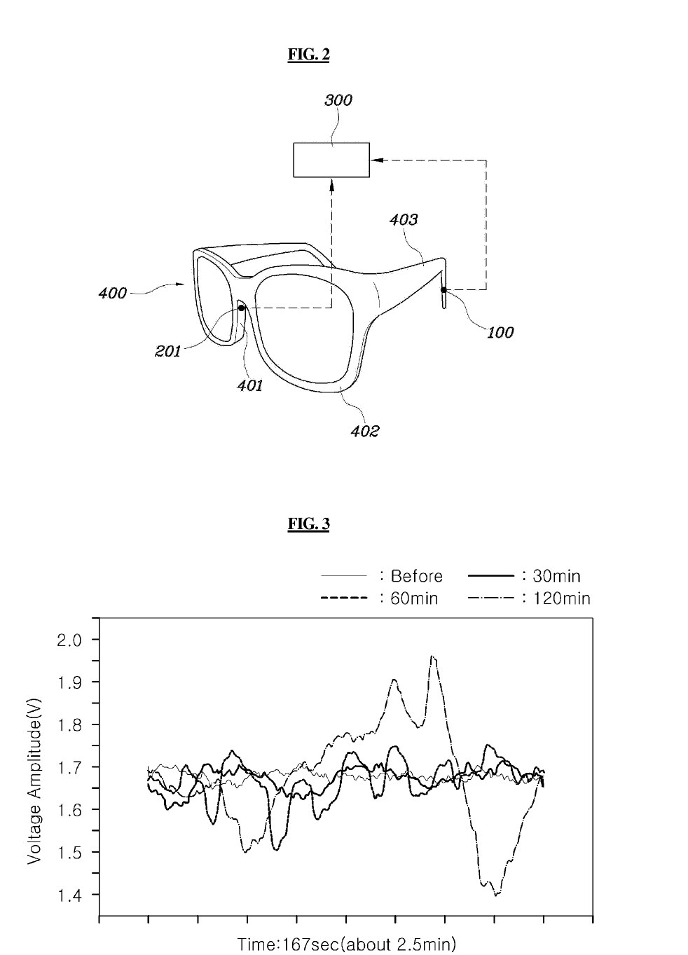

FIG. 2 is an exemplary view of an apparatus for measuring a driver's visual fatigue applied to a pair of spectacles according to an exemplary embodiment of the present invention. The apparatus may include a pair of spectacles 400 having a nose pad 401, lenses 402, and temple arms 403, a ground electrode 100 disposed at an end of the temple arms 403 near the driver's ear, a measuring electrode 200 disposed at the nose pad 401 near the driver's eye, and a controller 300 configured to induce a resting potential using measured values of the ground electrode 100 and the measuring electrode 200; determine the visual fatigue to be above a predetermined threshold when the resting potential is beyond a predetermined range; and output a fatigue signal.

Further, the measuring electrode 200 may comprise a plurality of electrode units disposed near the left and right sides of the driver's eye, respectively. Alternatively, the measuring electrode 200 may comprise a plurality of electrode units disposed near upper, lower, left, and right sides of the driver's eye, respectively. With such configuration, a driver may wear a spectacle-type measurer without discomfort to measure the eye-fatigue.

Further, the ground electrode may be disposed below the driver's ear using the steady temple arms of the spectacles, and the measuring electrode may be disposed on the nose pad, to examine the horizontal eye-movement and the eye-fatigue therefrom. However, for a more precise measurement, additional measuring electrodes may be disposed around the driver's eyes. Furthermore, additional measuring electrodes may be disposed above and below the eyes to more accurately measure variation in the resting potential. Such a configuration may additionally detect eye-movement, facilitating the intention of the driver.

Moreover, for installation of measuring electrodes at a variety of locations for obtaining more precise data, the spectacles may be goggle-type spectacles.

The controller may be configured to examine the resting potential and determine the eye-fatigue, and when the eye-fatigue is determined to be above a predetermined threshold according to a certain reference, the controller may be configured to output a fatigue signal to warn the driver by for example, locking a display guider. The fatigue signal may be output stepwise or linearly according to a variety of references, thereby providing diversified and optimized service.

According to an apparatus for measuring a driver's visual fatigue, driving safety may be improved. Furthermore, the apparatus may define more definite determination standards with regard to a dangerous driving condition while measuring the driver's visual fatigue using cost-effective electrodes based on the principle of a human body, thereby improving operation performance in association with a driving system and thus enabling safe driving.

Further, since visual information is output to the driver in a vehicle via a cluster, AVN, HUD, or the like, the present technology may provide an optimized quantity of driving information (degree and standard) to the driver.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An apparatus for measuring a driver's visual fatigue comprising:
a ground electrode mounted at a location near the driver's ear;
a measuring electrode mounted at a location near the driver's eye; and
a controller configured to:
induce a resting potential using measured values of the ground electrode and the measuring electrode;
determine the visual fatigue to be above a predetermined threshold when the resting potential is beyond a predetermined range; and
output a fatigue signal.

2. The apparatus according to claim 1, wherein the measuring electrode is mounted at a location between the driver's eye and nose.

3. The apparatus according to claim 1, wherein the controller is configured to determine the visual fatigue to be above the predetermined threshold when the resting potential is below 1.6 mV or above 1.8 mV.

4. The apparatus according to claim 1, wherein the controller is configured to output the fatigue signal when the resting potential is below 1.6 mV or above 1.8 mV for a certain length of time.

5. An apparatus for measuring a driver's visual fatigue comprising:
a pair of spectacles having a nose pad, lenses, and temple arms;
a ground electrode disposed at an end of the temple arms at a location near the driver's ear;
a measuring electrode disposed at the nose pad at a location near the driver's eye; and
a controller configured to:
induce a resting potential using measured values of the ground electrode and the measuring electrode;
determine the visual fatigue to be above a predetermined threshold when the resting potential beyond a predetermined range; and
output a fatigue signal.

6. The apparatus according to claim 5, wherein the measuring electrode comprises a plurality of electrode units disposed at a location near the left and right sides of the driver's eye, respectively.

7. The apparatus according to claim 5, wherein the measuring electrode comprises a plurality of electrode units disposed at a location near the upper, lower, left, and right sides of the driver's eye, respectively.

8. A non-transitory computer readable medium containing program instructions executed by a processor or controller, the computer readable medium comprising:
program instructions that induce a resting potential using measured values of the ground electrode and the measuring electrode
program instructions that determine the visual fatigue to be above a predetermined threshold when the resting potential beyond a predetermined range; and
program instructions that output a fatigue signal.
